(19) United States
(12) Patent Application Publication
(10) Pub. No.: US 2026/0108878 A1
(43) Pub. Date: Apr. 23, 2026

(54) MICROFLUIDIC MODULES AND INTERFACE COMPONENTS

(71) Applicant: VIRGINIA TECH INTELLECTUAL PROPERTIES, INC., Blacksburg, VA (US)

(72) Inventors: Masoud Agah, Blacksburg, VA (US); Nipun Thamatam, Blacksburg, VA (US)

(21) Appl. No.: 19/111,530

(22) PCT Filed: Jul. 21, 2023
(86) PCT No.: PCT/US2023/028399

§ 371 Date: Mar. 13, 2025

Related U.S. Application Data
(60) Provisional application No. 63/409,114, filed on Sep. 22, 2022.

(51) Int. Cl. B01L 3/00

(52) U.S. Cl. CPC B01L 3/502715; B01L 2200/025; B01L 2200/027; B01L 2200/04; B01L 2200/10; B01L 2300/043; B01L 2300/0819; B01L 2300/12; B01L 2400/0406

(57) ABSTRACT

An apparatus may include a microfluidic chip including at least one microfluidic channel and a first at least one electrical interconnect. An apparatus may include a circuit board having at least one interface interconnect and a second at least one electrical interconnect electrically coupled with the first at least one electrical interconnect of the microfluidic chip. An apparatus may include a cartridge enclosing the microfluidic chip and the circuit board, the cartridge including at least one opening allowing access to the at least one microfluidic channel on the microfluidic chip and the at least one interface interconnect.

### CROSS-REFERENCE TO RELATED APPLICATIONS

This application claims priority to U.S. Provisional Patent Application No. 63/409,114, filed on Sep. 22, 2022, and entitled “Fluidic and Electrical Modular Interface (FEMI) for Making Micro Analytical Instruments and the Like,” the entirety of which is incorporated by reference herein.

### STATEMENT REGARDING FEDERALLY SPONSORED RESEARCH OR DEVELOPMENT

This invention was made with government support under award R01OH011350 awarded by the National Institute for Occupational Safety and Health.

### TECHNICAL FIELD

This disclosure relates to microfluidics, and in particular to fluidic and electrical modular interfaces.

### DESCRIPTION OF THE RELATED TECHNOLOGY

Micro analytical instruments can include micro-Total Analysis Systems (μTAS), which are integrated systems where one or more components are developed using micro or nano technologies. These components can include microelectronic and (micro) fluidic components that can be in fluidic and electrical communication with each other and components outside of the instrument. The operational efficiency of the integrated system can depend on the fluidic and electrical interfacing between the various microfluidic and electrical components and also between the instrument and the outside world for sample and reagent introduction. Dead volumes, cold/condensation spots, long transfer lines, improper fitting and adapters, and sample loss are some issues that can negatively affect system performance.

### SUMMARY

In some aspects, the techniques described herein relate to an apparatus, including: a microfluidic chip including at least one microfluidic channel and a first at least one electrical interconnect; a circuit board having at least one interface interconnect and a second at least one electrical interconnect electrically coupled with the first at least one electrical interconnect of the microfluidic chip; and a cartridge enclosing the microfluidic chip and the circuit board, the cartridge including at least one opening allowing access to the at least one microfluidic channel on the microfluidic chip and the at least one interface interconnect.

In some aspects, the techniques described herein relate to an apparatus, wherein the microfluidic chip includes at least one electronic component coupled with the at least one microfluidic channel and electrically coupled with the first at least one electrical interconnect.

In some aspects, the techniques described herein relate to an apparatus, wherein the cartridge includes at least one alignment feature on an inner surface of the cartridge, wherein the microfluidic chip further includes complementary at least one alignment feature that engages with the at least one alignment feature.

In some aspects, the techniques described herein relate to an apparatus, wherein the microfluidic chip includes at least one opening to the at least one microfluidic channel, wherein a portion of the cartridge over the at least one opening includes a magnifying lens.

In some aspects, the techniques described herein relate to an apparatus, wherein the cartridge includes a first side defining a first opening of the at least one opening and a second side defining a second opening of the at least one opening, wherein the first opening allows access to the at least one microfluidic channel and the second opening allows access to the at least one interface interconnect.

In some aspects, the techniques described herein relate to an apparatus, wherein the cartridge includes a first side defining the at least one opening.

In some aspects, the techniques described herein relate to an apparatus, wherein the cartridge includes a retractable cover, which in a retracted state exposes an internal volume of the cartridge and in a closed state presses the microfluidic chip against the circuit board.

In some aspects, the techniques described herein relate to an apparatus, wherein the cartridge includes a hinge coupled with the retractable cover.

In some aspects, the techniques described herein relate to an apparatus, wherein the cartridge includes sliding grooves on an inner surface of the cartridge, the sliding grooves accommodating the retractable cover and allowing the retractable cover to slide in and out of the cartridge.

In some aspects, the techniques described herein relate to an apparatus, further including spring contacts positioned between the first at least one interconnect and the second at least one interconnect, the spring contacts providing electrical contact between the first at least one interconnect and the second at least one interconnect and a force pushing the circuit board away from the microfluidic chip, wherein the cartridge compress-fits the circuit board against the microfluidic chip.

In some aspects, the techniques described herein relate to an apparatus, further including a spacer positioned between an inner surface of the cartridge and one of the microfluidic chip or the circuit board, a thickness of the spacer being selected to align the at least one microfluidic channel on the microfluidic chip and the at least one interface interconnect on the circuit board with the at least one opening.

In some aspects, the techniques described herein relate to an apparatus, wherein the circuit board includes at least one control circuit communicably coupled with the at least one electronic component on the microfluidic chip.

In some aspects, the techniques described herein relate to an apparatus, further including: a coupling board, including: a first surface and an opposite facing second surface, at least one conduit that extends between the first surface and the second surface, and at least one fastening feature; a capillary tube that extends through the at least one conduit in the coupling board, wherein the cartridge includes: a first side defining a first opening of the at least one opening, the first side including at least one cartridge fastening feature that engages with the at least one fastening feature on the coupling board, wherein the capillary tube extends through the first opening in the cartridge and is in fluid communication with the at least one microfluidic channel.

In some aspects, the techniques described herein relate to an apparatus, further including: a septum positioned within the at least one conduit in the coupling board and positioned at an intersection of the capillary tube and the at least one microfluidic channel to form a fluidic-tight seal, wherein the septum includes a septum capillary tube conduit and wherein the capillary tube extends through the septum capillary tube conduit.

In some aspects, the techniques described herein relate to an apparatus, further including: a fluidic adapter positioned on the first surface of the coupling board, the fluidic adapter including an adapter capillary tube conduit, wherein the capillary tube extends through the adapter capillary tube conduit.

In some aspects, the techniques described herein relate to an apparatus, wherein the fluidic adapter includes at least one fastening features which engage with the at least one fastening features in the coupling board.

In some aspects, the techniques described herein relate to an apparatus, wherein the cartridge is a first cartridge, the microfluidic chip is a first microfluidic chip, and the circuit board is a first circuit board, the apparatus further including: a second microfluidic chip, a second circuit board, and a second cartridge enclosing the second microfluidic chip and the second circuit board, the second cartridge including at least one opening allowing access to at least one microfluidic channel on the second microfluidic chip and at least one interface interconnect on the second circuit board, the second cartridge further including a first side having at least one cartridge fastening feature, wherein the second cartridge is positioned on the second surface of the coupling board, wherein the at least one cartridge fastening feature of the second cartridge engages with the at least one fastening feature of the coupling board, and wherein the capillary tube extends between the at least one microfluidic channel in the first microfluidic chip and the at least one microfluidic channel in the second microfluidic chip through the at least one conduit in the coupling board.

In some aspects, the techniques described herein relate to an apparatus, wherein the at least one conduit includes a plurality of conduits and the at least one fastener feature includes a plurality of fastener features, wherein for each conduit of the plurality of conduits there is a corresponding set of fastener features from the plurality of fastener features, and wherein a relative position of a first conduit from the plurality of conduits with respect to its corresponding set of fastener features from the plurality of fastener features is same as a relative position of every other conduit of the plurality of conduits with respect to its corresponding set of fastener features form the plurality of fastener features.

In some aspects, the techniques described herein relate to an apparatus, wherein the plurality of conduits are positioned in an array of rows and columns.

In some aspects, the techniques described herein relate to an apparatus, further including: a plurality of cartridges, including the cartridge, positioned on the first surface of the coupling board; a plurality of fluidic adapters positioned on the second surface of the coupling board, each of the plurality of fluidic adapters including an adapter capillary tube conduit, wherein a capillary tube extends between a first cartridge of the plurality of cartridges and a second cartridge of the plurality of cartridges and passes through a first conduit of the plurality of conduits, an adapter capillary conduit of a first fluidic adapter of the plurality of fluidic adapters, an adapter capillary conduit of a second fluidic adapter of the plurality of fluidic adapters, and a second conduit of the plurality of conduits.

In some aspects, the techniques described herein relate to an apparatus, further including: a plurality of cartridges, including the cartridge, positioned on the first surface of the coupling board, wherein each cartridge includes a microfluidic channel having an inlet and an outlet, wherein inlets of the plurality of cartridges are aligned with a first set of conduits of the plurality of conduits and wherein outlets of the plurality of cartridges are aligned with a second set of conduits of the plurality of conduits, a first parallel coupling board and a second parallel coupling board positioned on the second surface of the coupling board, the first parallel coupling board including a first network of microfluidic channels having an inlet and a plurality of outlets in fluid communication with the inlet, and the second parallel coupling board including a second network of microfluidic channels having a plurality of inlets and an outlet in fluid communication with the plurality of inlets, wherein the plurality of outlets of the first parallel coupling board are aligned with the first set of conduits of the coupling board, and wherein the plurality of inlets of the second parallel coupling board are aligned with the second set of conduits of the coupling board.

In some aspects, the techniques described herein relate to an apparatus, further including: a plurality of cartridges, including the cartridge, positioned on the first surface of the coupling board, wherein each cartridge includes a microfluidic channel having an inlet and an outlet, wherein inlets of the plurality of cartridges are aligned with a first set of conduits of the plurality of conduits and wherein outlets of the plurality of cartridges are aligned with a second set of conduits of the plurality of conduits, a parallel coupling board including a plurality of microfluidic channels, each microfluidic channel including a coupling board inlet and a coupling board outlet, wherein coupling board inlets are aligned with the second set of conduits in the coupling board and the wherein coupling board outlets are aligned with the first set of conduits of the coupling board.

### BRIEF DESCRIPTION OF THE DRAWINGS

FIG. 1 shows a first example microfluidic apparatus.

FIG. 2 shows a first (top) exploded view of the first example microfluidic apparatus while FIG. 3 shows a second (bottom) exploded view of the first example microfluidic apparatus.

FIG. 4 shows a front view of the first example microfluidic apparatus discussed above in relation to FIGS. 1-3.

FIGS. 5A-5D show various microfluidic components that can be interfaced with each other to form a microfluidic system.

For example, FIG. 5E shows an expanded view of the one or more side ports.

FIG. 6 shows first example microfluidic apparatus discussed above in relation to FIGS. 1-4 but without a top portion of the cartridge.

FIG. 7 shows the cartridge discussed above in relation to FIGS. 1-4 including a retractable cover.

FIG. 8 shows the first example microfluidic apparatus including one or more magnifying lenses positioned in alignment with the one or more side ports.

FIG. 9 shows a second example microfluidic apparatus.

FIG. 10 shows a third example microfluidic apparatus.

FIG. 11 shows a fourth example microfluidic apparatus.

FIG. 12 shows a fifth example microfluidic apparatus that includes a coupling board to couple capillary tubes to the microfluidic chip.

FIG. 13 shows a cross-sectional view of the fifth example microfluidic apparatus shown in FIG. 12.

FIG. 14 shows a microfluidic system in which two microfluidic modules are coupled together.

FIG. 15 shows cross-sectional views of the microfluidic system shown in FIG. 14 along an axis.

FIG. 16 shows an example coupling board including multiple conduits.

FIG. 17 shows an example microfluidic system based on the coupling board shown in FIG. 16.

FIG. 18 shows an example septum for use in coupling boards with multiple overlapping conduits.

FIG. 19 shows an example thumb screw adapter that can be utilized in a microfluidic system.

FIG. 20 shows a side view of the microfluidic system shown in FIG. 7.

FIG. 21 shows the routing of the capillary tubes between two microfluidic modules.

FIG. 22 shows a second microfluidic system where microfluidic modules are positioned on both sides of the coupling board.

While FIG. 22 shows an exploded view of the electrical connector and the microfluidic module.

FIG. 23 shows a perspective view of the electrical connector and the microfluidic module coupled with the coupling board.

FIG. 24 shows a third microfluidic system that represents a micro gas chromatography system with near-zero dead volume chip-chip connections.

FIG. 25 shows a fourth microfluidic system for use during development of microfluidic chips.

FIG. 26 shows a fifth microfluidic system.

FIG. 27 shows various examples of microfluidic systems that can be implemented with coupling boards such as those discussed above in relation to FIGS. 25-26.

Like reference numbers and designations in the various drawings indicate like elements.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used in the specification and the appended claims, the singular forms “a,” “an” and “the” include plural referents unless the context clearly dictates otherwise. Thus, for example, reference to “a proton beam degrader,” “a degrader foil,” or “a conduit,” includes, but is not limited to, two or more such proton beam degraders, degrader foils, or conduits, and the like.

The various concepts introduced above and discussed in greater detail below may be implemented in any of numerous ways, as the described concepts are not limited to any particular manner of implementation. Examples of specific implementations and applications are provided primarily for illustrative purposes.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

One approach to providing fluidic or electrical communication between various components of a microfluidic system or instrument is to manufacture the components and the interface therebetween on a monolithic integrated chip. Such a chip can provide reliable interfaces between the components, but do not lend themselves easily to maintenance, modifications, and repair. In another approach, individual microfluidic components are manufactured separately and are interfaced permanently using capillary tubing and sealing agents such as, for example, epoxies. While this approach can provide some advantages with respect to maintenance and repair, such systems can suffer from increase in dead volumes and decrease in system performance.

Individual components include ports to interface with tubing or other components using structures such as, for example, NanoPorts and o-rings. In some examples, these ports are positioned on the top of the components. That is, the port is positioned approximately normal to the path of the fluid within the component. While this top port approach may be suitable for some applications, the approach can limit the number of ports that can be accommodated due to the large sizes of the interfacing materials.

Many microfluidic components include electrical chips, which also need to be interfaced with other components. In some examples, electrical communication between components can be provided by soldering or wire-bonding interconnects to the components. This approach however can reduce the modularity of the components as the soldering and wire-bonding may not allow for ease of disconnecting and reconnecting.

One or more approaches are discussed herein in relation to microfluidic systems such as, for example, microfluidic components, modular microfluidic components, removeable electrical and fluidic connections between microfluidic components, coupling boards, etc. One or more of these approaches can address the drawbacks of various other approaches discussed above. In some examples, microfluidic components can have removable electrical and gas- or liquid-tight fluidic connections, providing the ability to readily modify the microfluidic system. That is, such as component alleviates the need for permanent connections between components and creates the ability to replace each component with ease. As a result, components with different functionalities can be easily added or removed. In some examples, microfluidic components can have side ports, which lend themselves to coupling with fluidic connections.

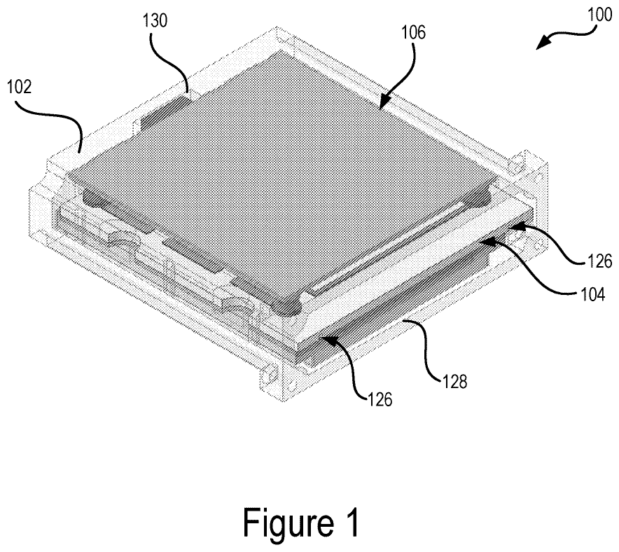

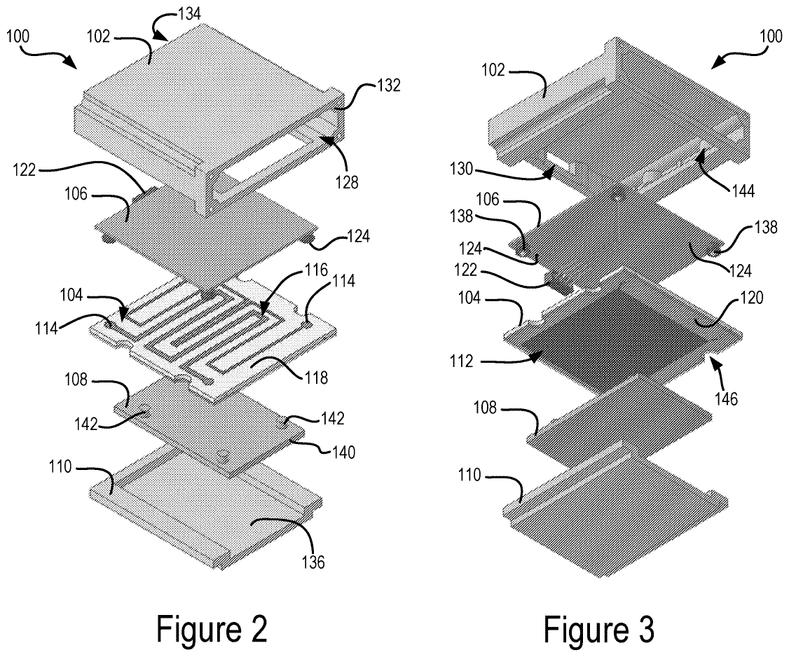

FIG. 1 shows a first example microfluidic apparatus 100. In particular, the first example microfluidic apparatus 100 includes a cartridge 102, a microfluidic chip 104, and a circuit board 106. FIG. 2 shows a first (top) exploded view of the first example microfluidic apparatus 100 while FIG. 3 shows a second (bottom) exploded view of the first example microfluidic apparatus 100. FIGS. 2 and 3 additionally show a spacer 108 and a retractable cover 110. The microfluidic chip 104 can include at least one microfluidic channel 112 and a first at least one electrical interconnect 114. The at least one microfluidic channel 112 can be part of a larger microfluidic system, for example. The first at least one electrical interconnect 114 can provide transmission of electrical signals, and in some instances be coupled with one or more electronic components on the microfluidic chip 104. For example, as shown in FIG. 2, the microfluidic chip 104 can include an electrical component 116, which can include passive (e.g., resistor, capacitor, inductor, sensor, etc.) or active (e.g., transistor, diode, logic circuit, etc.) electronic components. In some examples, the electrical component 116 can provide heating by way of a resistor coupled with the first at least one electrical interconnect 114 such that flow of current through the electrical component 116 can provide heating to the microfluidic chip 104. In the microfluidic chip 104 shown in FIGS. 2 and 3, the microfluidic chip 104 can include a first surface 118 over which the electrical component 116 is positioned and a second surface 120 over which the at least one microfluidic channel 112 is positioned. Of course, this is only an example, and the microfluidic chip 104 may or may not include any electrical component 116 at all or may include the electrical component 116 and the at least one microfluidic channel 112 on the same surface and not necessarily on different surfaces of the microfluidic chip 104. The microfluidic chip 104 can include one or more side ports 126 that provide openings to the at least one microfluidic channel 112. The one or more side ports 126 (as discussed further below) are positioned on a side surface of the microfluidic chip 104.

The circuit board 106 can include at least one interface interconnect 122 and a second at least one electrical interconnect 124 coupled with the first at least one electrical interconnect 114. In the example shown in FIGS. 2 and 3, a contact coupling is used between the second at least one electrical interconnect 124 and the first at least one electrical interconnect 114, however, in some instances a permanent coupling may be used, such as a flexible wire or interconnect. In some instances, the coupling can be spring loaded (e.g., spring contacts 138) that can allow for secure electrical contact between the interconnects. The spring contacts not only provide electrical contact between the first at least one electrical interconnect 114 and the second at least one electrical interconnect 124 but also provide a force that pushes the circuit board 106 away from the microfluidic chip 104. The cartridge 102 compress fits the circuit board 106 and the microfluidic chip 104, and this compression fit allows for a strong electrical contact provided by the spring contacts. The at least one interface interconnect 122 can be used to connect to entities outside of the first example microfluidic apparatus 100. The circuit board 106 can include circuitry related to the operation of the first example microfluidic apparatus 100 and can include electrical components (active and/or passive), microcontrollers, processors, memory, application specific integrated circuits, field programmable gate arrays, etc. These electrical components can be coupled with the second at least one electrical interconnect 124 and the at least one interface interconnect 122 to receive and send electrical signals as wells as electrical power. The circuitry can include at least one control circuit that is communicably coupled with the at least one electronic component on the microfluidic chip 104. As an example, the control circuit can include a temperature monitoring circuit or a program running on a microcontroller, microprocessor, ASIC, FPGA, etc., that communicates with an electrical heater (e.g., a resistive heating element) and a sensor (e.g., a thermocouple) that can control the temperature of the desired portion of the microfluidic chip 104.

As shown in FIG. 1, the circuit board 106 and the microfluidic chip 104 can be positioned within the cartridge 102. The cartridge 102 can include at least one opening allowing access to the at least one microfluidic channel 112 on the microfluidic chip 104 and the at least one interface interconnect 122. For example, the cartridge 102 can include a first opening 128 that allow access to the one or more side ports 126 of the microfluidic chip 104 and a second opening 130 that allows access to the at least one interface interconnect 122. In the example shown in FIGS. 1-3, the first opening 128 and the second opening 130 are positioned on opposite ends or sides of the cartridge 102. For example, the cartridge 102 includes a first side 132 that defines the first opening 128 and a second side 134 that defines the second opening 130. However, the openings can be positioned on any side of the cartridge 102 and their positions can depend on the relative positions of the one or more side ports 126 and the at least one interface interconnect 122. In some examples, cartridge 102 can include a single side that defines both the first opening 128 and the second opening 130.

The first example microfluidic apparatus 100 may also include a spacer 108 positioned between an inner surface of the cartridge 102 and one of the circuit board 106 or the microfluidic chip 104. For example, the spacer 108 shown in FIGS. 1-3 is positioned between an inner surface 136 of the retractable cover 110, which is part of the cartridge 102, and the microfluidic chip 104. In some examples, the spacer 108 can be positioned between the inner surface 136 of the retractable cover 110 and the circuit board 106. In some examples, the spacer 108 can be positioned between the circuit board 106 and the microfluidic chip 104. In some examples, the spacer 108 can be positioned between two circuit boards or between two microfluidic chips.

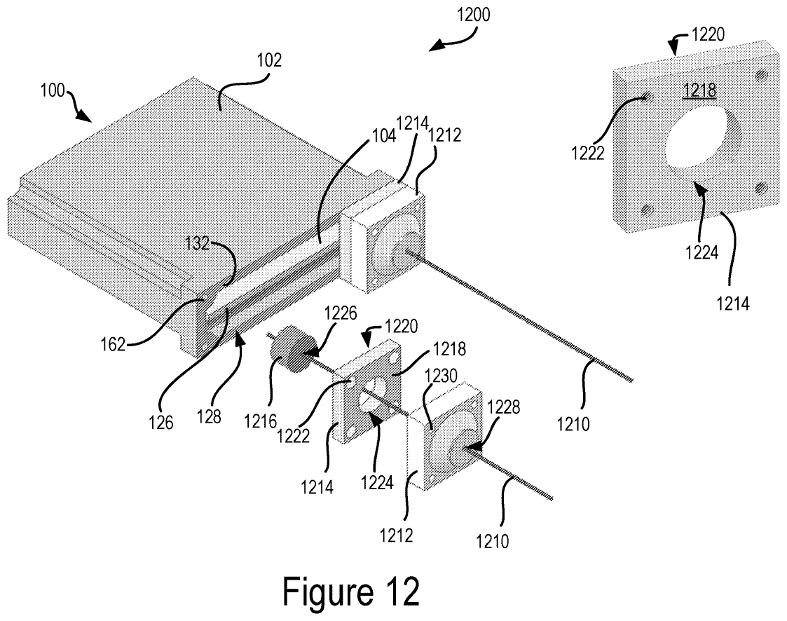

The spacer 108 can have a thickness that helps align the openings of the at least one microfluidic channel 112 on the microfluidic chip 104 and the at least one interface interconnect 122 with at least one opening. For example, the 108 can have a thickness that aligns the one or more side ports 126 of the at least one microfluidic channel 112 with the first opening 128 and align the at least one interface interconnect 122 with the second opening 130. With respect to the one or more side ports 126, the spacer 108 can be sized in particular to align the one or more side ports 126 with one or more capillary tubes positioned to couple with the one or more side ports 126. For example, as discussed further in relation to FIG. 12, the spacer 108 can have a thickness that allows the one or more side ports 126 to align with the capillary tube 1210. In some examples, where the cartridge 102 can be sized such that when the microfluidic chip 104 and the circuit board 106 are positioned inside the cartridge 102 and the retractable cover 110 is closed, the at least one microfluidic channel 112 and the at least one interface interconnect 122 may be aligned with the first opening 128 and the second opening 130 without the need for the spacer 108. The spacer 108 can include a base 140 and one or more pillars 142 that extend outwardly from the base 140. The base 140 can be a plate shaped structure of substantially uniform thickness. The one or more pillars 142 can be cylindrical structures that extend substantially normal to the surface of the base 140. In some instances, the one or more pillars 142 can extend on both sides of the base 140 instead of only one side as shown in FIGS. 2 and 3. The thickness of the spacer 108 can include the thickness of the base 140 and the height of the one or more pillars 142 from the base 140. In some instances, the spacer 108 may not include any pillars, and the thickness of the spacer 108 can then be the thickness of the base 140. Example thickness of the spacer 108 can be up to 50 mm.

It should be noted that the first example microfluidic apparatus 100 is not limited to a single microfluidic chip 104 and a single circuit board 106 as shown in FIGS. 1-3, and that the first example microfluidic apparatus 100 can include more than one microfluidic chip 104 and more than one circuit board 106.

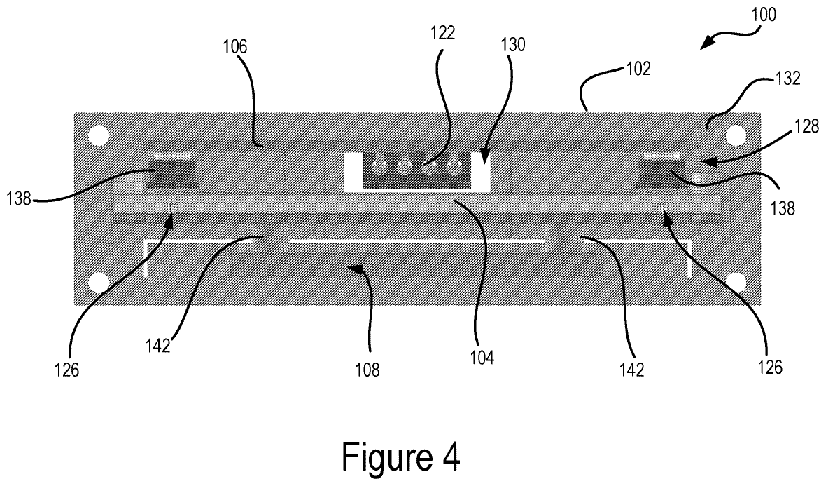

FIG. 4 shows a front view of the first example microfluidic apparatus 100 discussed above in relation to FIGS. 1-3. The circuit board 106 is spaced apart in relation to the microfluidic chip 104 and separated by the spring contacts 138. The microfluidic chip 104 is positioned between the circuit board 106 and the spacer 108, which in turn is positioned between the microfluidic chip 104 and the inner surface of the cartridge 102. The thickness of the spacer 108 is selected such that the one or more side ports 126 of the at least one microfluidic channel 112 are accessible through the first opening 128 and the at least one interface interconnect 122 is accessible through the second opening 130. The relative positions of the microfluidic chip 104, the circuit board 106 and the spacer 108 shown in FIG. 4 is only an example, and that these can be arranged in any order as long as the one or more side ports 126 and the at least one interface interconnect 122 are accessible from outside of the cartridge 102.

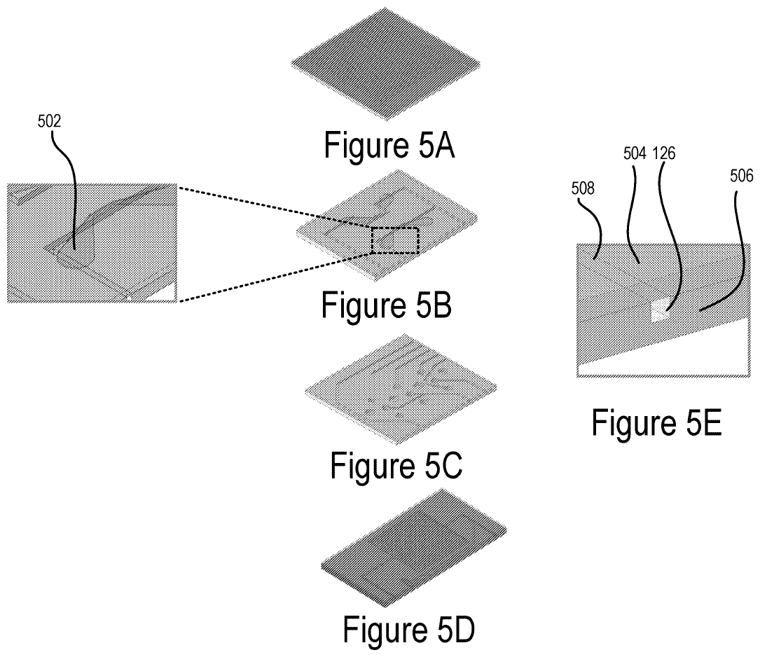

FIGS. 5A-5D show various microfluidic components that can be interfaced with each other to form a microfluidic system. In particular, FIG. 5A shows a separation column, FIG. 5B shows a detector, FIG. 5C shows a fluidic routing board, and FIG. 5D shows a preconcentrator. In some examples, the microfluidic components shown in FIGS. 5A-5D can be interfaced with each other to form a micro gas chromatography system. One or more of the microfluidic components can include electrical contacts, such as the first at least one electrical interconnect 114 discussed above in relation to FIGS. 1-3. For example, FIG. 5B shows an expanded view of the portion of the detector including contact pads 502. These contact pads 502 can be coupled to electrical interconnects, which, in turn, can couple with other electrical components on the microfluidic chip. One or more of the microfluidic components shown in FIGS. 5A-5D can include side ports. For example, FIG. 5E shows an expanded view of the one or more side ports 126. The microfluidic chip can include top surface 504 and an adjacent side surface 506. A microfluidic channel 508 is formed within the top surface and can terminate at the adjacent side surface 506. While in some traditional microfluidic chips, a port may be formed on the top surface 504 to access the microfluidic channel, in one or more microfluidic chips discussed herein, there may not be a top port, and instead, the microfluidic channel 508 can terminate at the adjacent side surface 506 of the chip to form a side port 126.

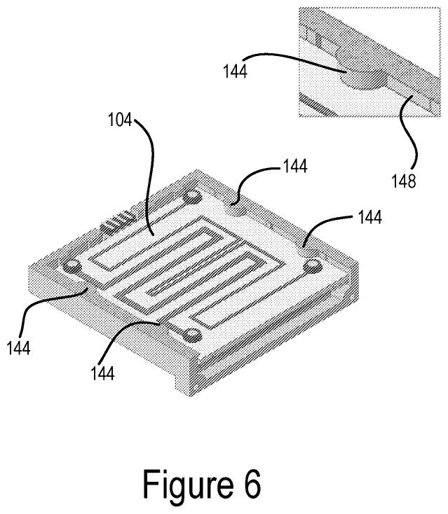

FIG. 6 shows first example microfluidic apparatus 100 discussed above in relation to FIGS. 1-4 but without a top portion of the cartridge 102. The top portion of the cartridge 102 is not shown to show alignment features more clearly. In particular, the cartridge 102 can include at least one alignment feature 144 formed on an inner surface 148 of the cartridge 102. The at least one alignment feature 144 can be a notch-like protrusion that extends out of the inner surface 148. The at least one alignment feature 144 in the example shown in FIG. 4 has a semicircular cross-section, but can in other examples have other shapes (e.g., rectangular, square, oval, etc.). The example shown in FIG. 6 includes 4 alignment features. However, the cartridge 102 may include fewer or additional alignment features. In some instances, only one alignment feature may be included. In some other instances, two alignment features may be included, one each on opposite inner surfaces of the cartridge 102. The microfluidic chip 104 can include complementary alignment features that engage with the at least one alignment feature 144 of the cartridge 102. For example, referring to FIG. 3, the microfluidic chip 104 can include at least one complementary alignment feature 146, which aligns with the at least one alignment feature 144 on the inner surface 148 of the cartridge 102. The at least one complementary alignment feature 146 can be formed in at least a portion of the side surface of the microfluidic chip 104. The relative positions of the at least one alignment feature 144 and the at least one complementary alignment feature 146 are such that when the microfluidic chip 104 is positioned within the cartridge 102, the at least one alignment feature 144 mate or align with the at least one complementary alignment feature 146. This ensures that the microfluidic chip 104 stays secure within the cartridge 102 and reduces the risk of movement of the 104 in response to external forces.

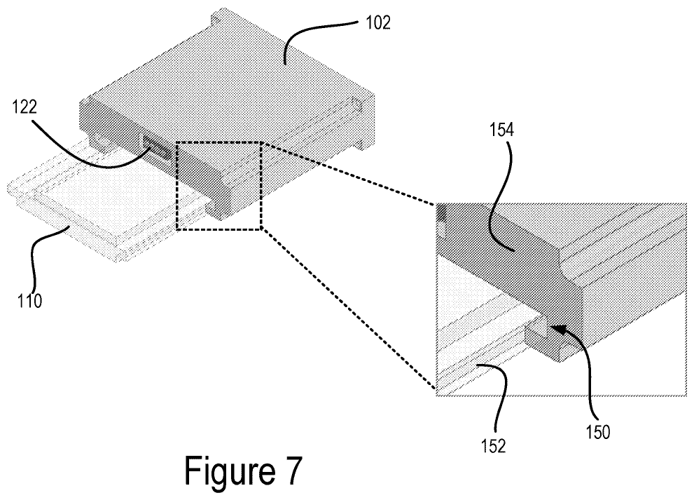

FIG. 7 shows the cartridge 102 discussed above in relation to FIGS. 1-4 including a retractable cover 110. In the closed position, the retractable cover 110 presses the microfluidic chip 104 against the circuit board 106 as shown in FIG. 1. In the retracted state, the retractable cover 110 exposes an internal volume of the cartridge 102. In the example shown in FIGS. 1-4 and 7, the retractable cover 110 can be slidably removed from the cartridge 102. To that end, the cartridge 102 can include sliding grooves 150 formed on an inner surface of the cartridge 102. The retractable cover 110 can include sliding protrusions 152 that are accommodated in the sliding grooves 150 thus allowing the retractable cover 110 to slide in an out of the cartridge 102. While not shown in FIG. 7, the outer side surface 154 can include a locking mechanism that locks the retractable cover 110 in position when the retractable cover 110 is completely retracted into the cartridge 102. The locking mechanism can include a latch or similar structure that can prevent the retractable cover 110 to slide out of the cartridge 102 unless the locking mechanism is released. In some instances, the retractable cover 110 can be coupled with the cartridge 102 with a hinge. In this manner, the retractable cover 110 can be opened and closed by pivoting on the hinge instead of sliding in and out of the retractable cover 110. The hinge can be coupled, for example, on the outer side surface 154 of the cartridge 102 and an outside side surface of the retractable cover 110. In some such instances, locking mechanism can be positioned on the sides of the cartridge 102 to help secure the hinged retractable cover 110 to the cartridge 102 in a closed position.

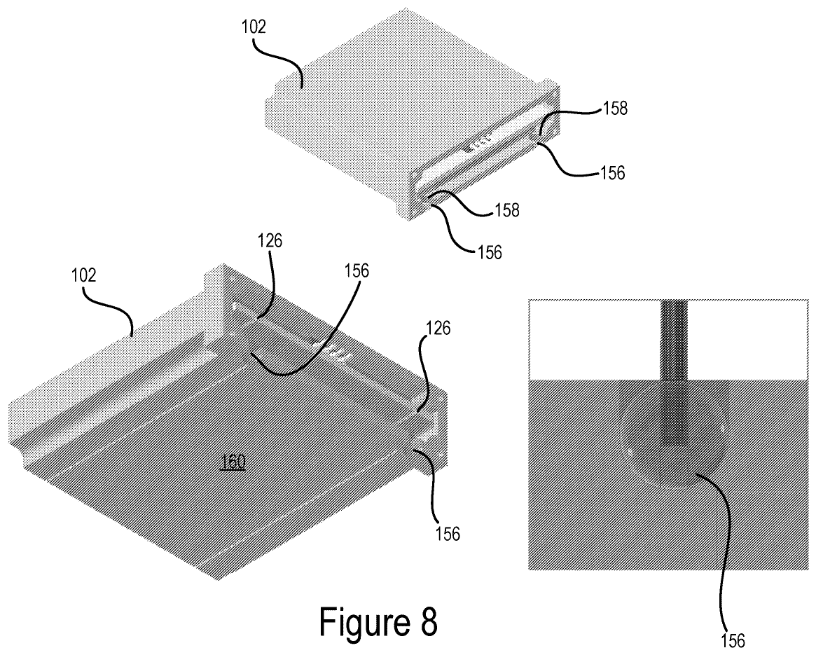

FIG. 8 shows the first example microfluidic apparatus 100 including one or more magnifying lenses 156 positioned in alignment with the one or more side ports 126. The magnifying lenses make it easier to insert capillary tubes into the one or more side ports 126. The one or more magnifying lenses 156 can be formed of substantially transparent plastic or glass and can be shaped in a manner such that when the cartridge 102 is viewed in a direction normal to the bottom surface 160 of the cartridge 102, the one or more magnifying lenses 156 magnify at least a portion of the microfluidic chip 104 where the one or more side ports 126 are formed. In some instances, the bottom surface 160 of the 102 can define one or more apertures 158 that can house the one or more magnifying lenses 156.

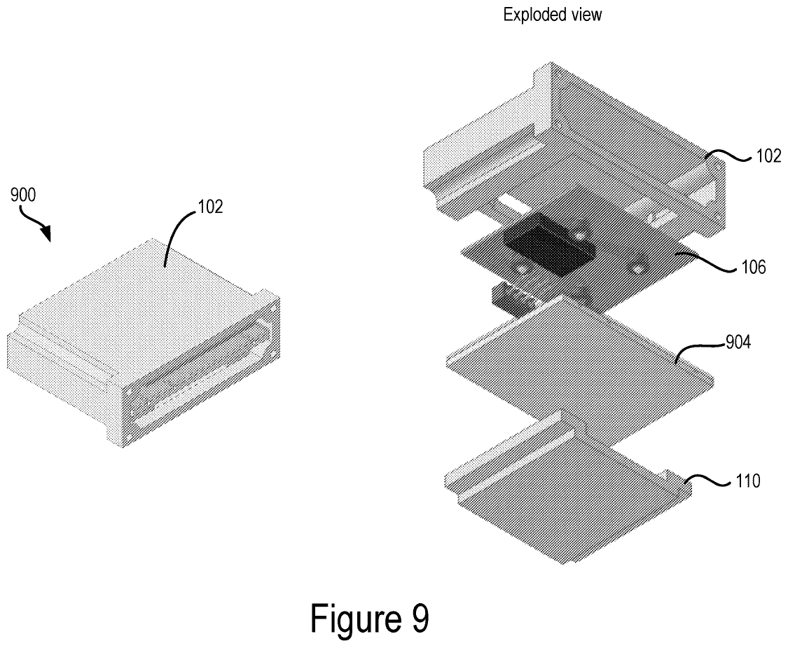

FIG. 9 shows a second example microfluidic apparatus 900. In many respects, the second example microfluidic apparatus 900 is similar to the first example microfluidic apparatus 100 discussed herein. However, the second example microfluidic apparatus 900 specifically includes a detector microfluidic chip 904 in place of the microfluidic chip 104 of the first example microfluidic apparatus 100. The features discussed above in relation to first example microfluidic apparatus 100 can, to the extent feasible, be applied to the second example microfluidic apparatus 900.

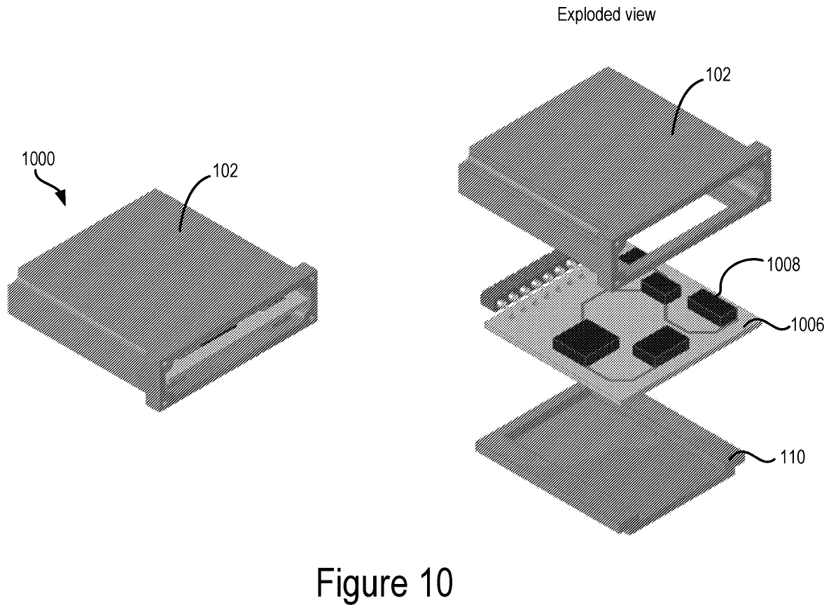

FIG. 10 shows a third example microfluidic apparatus 1000. In many respects, the third example microfluidic apparatus 1000 is similar to the first example microfluidic apparatus 100 discussed herein. However, the third example microfluidic apparatus 1000 specifically does not include a microfluidic chip, but includes a circuit board 1006 that has at least one application specific integrated circuit (ASIC) 1008. The features discussed above in relation to first example microfluidic apparatus 100 can, to the extent feasible, be applied to the third example microfluidic apparatus 1000.

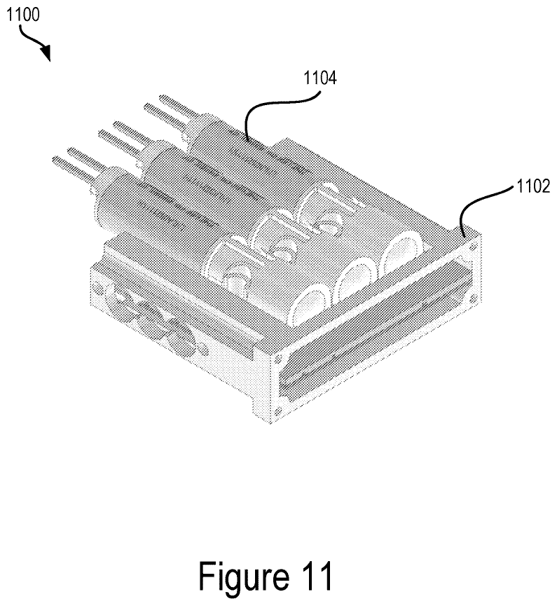

FIG. 11 shows a fourth example microfluidic apparatus 1100. In many respects, the fourth example microfluidic apparatus 1100 is similar to the first example microfluidic apparatus 100 discussed herein. However, the fourth example microfluidic apparatus 1100 includes valves or pumps 1104 housed within a cartridge 1102. The cartridge 1102 show in FIG. 11 has a open top portion to accommodate the valves or pumps 1104. However, in some other instances, the cartridge 1102 can be similar to the cartridge 102 discussed above in relation to the first example microfluidic apparatus 100 but can be relatively larger to entirely enclose the valves or pumps 1104.

With the examples shown in FIGS. 1, 9, and 10 it should be clear that the various microfluidic apparatus can be formed using the cartridge 102 and other internal components discussed herein. Each microfluidic apparatus can include one or more components of a microfluidic system. Each of these microfluidic apparatus can be viewed a microfluidic module, where a microfluidic system can be formed by interconnecting one or more microfluidic modules. The modular nature of the various components allows for ease of maintenance, ease of changing the microfluidic system, all at a reduced cost. In addition, traditional systems that included two or more microfluidic components on a single chip were a challenge to functionalize. Functionalizing a microfluidic component can typically include exposing the component to specific reagents. As a multi-component microfluidic chip includes multiple functionalizations, these functionalizations are carried out separately from the manufacturing process of the chip. This separate functionalization step removed from the manufacturing process can increase costs. However, the modular nature of the apparatus discussed herein allow each module to include microfluidic chips with fewer components or just a single component. As such, each module can be functionalized with its own reagent and the functionalization step can be part of the manufacturing workflow, thereby alleviating the additional cost of post manufacturing functionalization.

FIG. 12 shows a fifth example microfluidic apparatus 1200 that includes a coupling board to couple capillary tubes to the microfluidic chip. the fifth example microfluidic apparatus 1200 can include any one of the microfluidic apparatus discussed above that include a microfluidic chip such as, for example, the first example microfluidic apparatus 100. For ease of description, the fifth example microfluidic apparatus 1200 is discussed herein in relation to first example microfluidic apparatus 100, but it is understood that other apparatus (e.g., discussed above in relation to FIGS. 9-11) can also be employed.

The fifth example microfluidic apparatus 1200 includes a coupling board 1214 that facilitates the coupling of a capillary tube 1210 to the microfluidic chip. The coupling board 1214 includes a first surface 1218 and a opposite facing second surface 1220. The coupling board 1214 further includes at least one conduit 1224 that extends between the first surface 1218 and the opposite facing second surface 1220. The coupling board 1214 can also include at least one fastening feature 1222. In the example shown in FIG. 12, the at least one fastening feature can include an aperture that allows a fastener such as a screw or a nail or a bolt to pass through. The fifth example microfluidic apparatus 1200 further incudes a capillary tube 1210 that extends through the at least one conduit 1224 in the coupling board 1214. The first example microfluidic apparatus 100 includes the cartridge 102 having the first side 132 that defines the first opening 128. The first side 132 also includes at least one cartridge fastening feature 162 that can engage with the at least one fastening feature 1222 of the coupling board 1214. As discussed above, the microfluidic chip 104 includes a at least one microfluidic channel 112 that terminates at one or more side ports 126, which are exposed by the first opening 128. The capillary tube 1210 can extend through the at least one conduit 1224 of the coupling board 1214 and the first opening 128 of the cartridge 102 and is in fluid communication with the one or more side ports 126 of the microfluidic chip 104. For example, the capillary tube 1210 can have one end that is inserted into the one or more side ports 126 to form fluid communication with the at least one microfluidic channel 112.

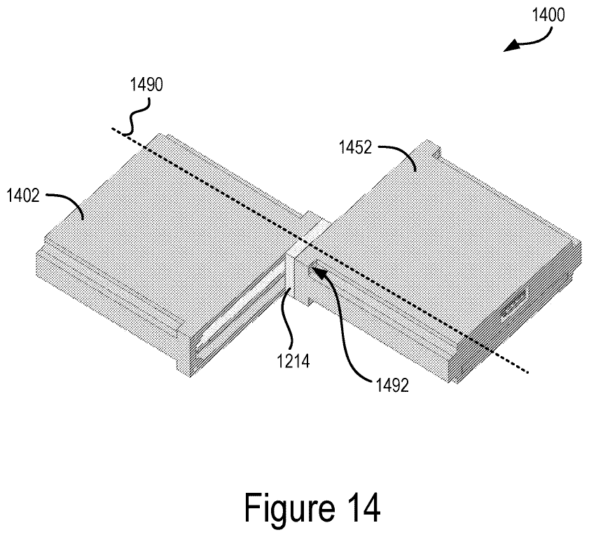

The coupling board 1214 generally be made of any rigid material. in some instances, the coupling board 1214 can be made of thermoplastics such as, for example, polyether ether ketone (PEEK), polyether ketone (PEK), nylon, Teflon, etc. in some examples, the coupling board 1214 can be made of metals such as, for example, stainless steel, aluminum, titanium, etc. In some instances, the coupling board 1214 can be made of a combination of thermoplastics and metals. In instances where thermal isolation is desired between two cartridges coupled with the same coupling board 1214 (such as, for example, discussed in relation to FIG. 14), the coupling board 1214 may be made predominantly or fully of plastics or other thermally insulating materials.

The thickness of the coupling board 1214 can be measured as the distance between the first surface 1218 and the opposite facing second surface 1220. This thickness can be, in some instances, based on the factors such as the desired thermal isolation between cartridges positioned on either side of the coupling board 1214 and the amount of dead volume that can be tolerated in the capillary tube passing through the coupling board 1214. For example, if high thermal isolation is needed, the coupling board 1214 can be relatively thicker. But if low dead volume in the capillary tube is needed, then a relatively thinner coupling board 1214 can be selected. In some examples, the coupling board 1214 can have a thickness of about 2 mm to about 10 mm.

The fifth example microfluidic apparatus 1200 can also include a septum 1216 positioned within the at least one conduit 1224 in the coupling board 1214. The septum 1216 can include a septum capillary tube conduit 1226. The capillary tube 1210 can extend through the septum capillary tube conduit 1226. The septum 1216 can be positioned at an intersection of the capillary tube 1210 and the one or more side ports 126 of the at least one microfluidic channel 112. In particular, the septum 1216 can be pressed against the side surface of the microfluidic chip 104 where the one or more side ports 126 are formed. In some instances, the septum 1216 can have a thickness that is greater than the thickness of the coupling board 1214. In some examples, the septum 1216 can be formed using insulating materials. An insulating septum 1216 can help thermally isolate the microfluidic channel in one cartridge from the microfluidic channel in another cartridge. This thermal isolation helps in effective maintenance of separate thermal conditions in separate cartridges that are coupled with the coupling board 1214.

The septum 1216 can be generally formed of any rigid or semi-rigid material. In some examples, the septum 1216 can be formed using silicone rubber or its variants. In some examples, materials such as perflouroelastomeric compounds (e.g., FFKM and FKM) can be used for improved thermal and chemical resistance. The septum 1216 can have a diameter that is less than the diameter of the at least one conduit 1224 of the coupling board 1214. In some instances, the diameter of the septum 1216 can be fractionally greater (e.g., approximately 1 mm or so greater) than the diameter of the at least one conduit 1224 to ensure that the septum 1216 is pressed securely within the at least one conduit 1224. The diameter of the 1216 is greater than the diameter of the septum capillary tube conduit 1226, which can be a function of the diameter of the capillary tube 1210. In some examples, the capillary tube 1210 can have a diameter of about 0.1 mm to about 2 mm. The septum capillary tube conduit 1226 of the septum 1216 can have a diameter that is equal to or greater than the diameter of the capillary tube 1210. However, depending on the degree of rigidity of the septum 1216, that is, depending on how compressible the material is of which the septum 1216 is made of, the inner diameter of the septum capillary tube conduit 1226 may be slightly less than the diameter of the capillary tube 1210 to allow for a press fit secure positioning of the capillary tube 1210 within the septum 1216. In some examples, the septum 1216 can have a diameter of about 3 mm to about 12 mm. The thickness of the septum 1216 can be based on factors such as the desired thermal isolation between cartridges positioned on either side of the septum 1216 and the amount of dead volume that can be tolerated in the capillary tube passing through the septum 1216. The thickness can also be based on the thickness of the coupling board 1214. For example, the thickness of the septum 1216 can be grater than the thickness of the coupling board 1214. The thickness may be made relatively larger if higher thermal isolation is needed or can be made relatively smaller if reduced amount of dead volume within the capillary tube 1210 is desired.

The fifth example microfluidic apparatus 1200 can further include a fluidic adapter 1212 positioned adjacent to the first surface 1218 of the coupling board 1214. The fluidic adapter 1212 includes an adapter capillary tube conduit 1228, and the capillary tube 1210 can extend through the adapter capillary tube conduit 1228. The fluidic adapter 1212 also can include at least one fastening feature 1230 that aligns with the corresponding fastening features in the coupling board 1214 and the cartridge 102.

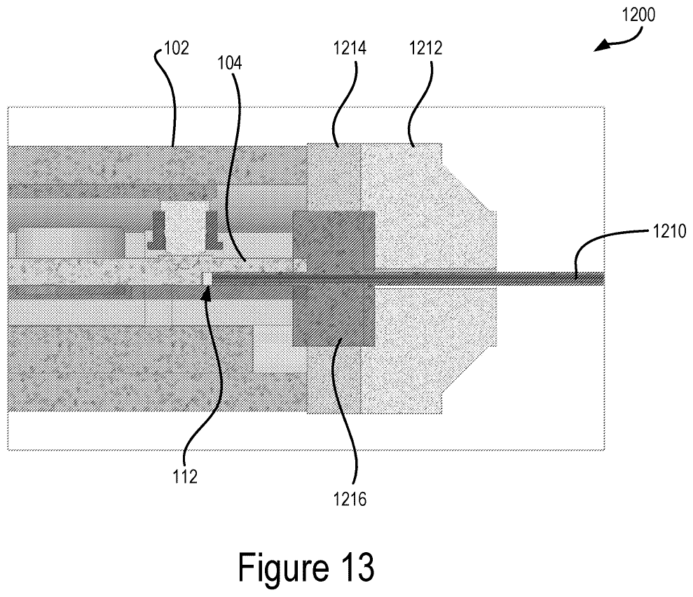

FIG. 13 shows a cross-sectional view of the fifth example microfluidic apparatus 1200 shown in FIG. 12. The fluidic adapter 1212 and the coupling board 1214 are coupled with the first side 132 with the coupling board 1214 positioned between the fluidic adapter 1212 and the cartridge 102. The capillary tube 1210 passes through the conduits in the fluidic adapter 1212, the coupling board 1214 and the septum 1216 and couples with the one or more side ports 126 of the at least one microfluidic channel 112. With the coupling board 1214 and the fluidic adapter 1212 fastened to the first side 132 of the cartridge 102, the septum 1216 is pressed against the adjacent side surface (see e.g., FIG. 5E, 506) of the microfluidic chip 104 where the one or more side ports 126 is positioned. The septum 1216 can be made of a compressible material such as, for example, silicone rubber. With the septum 1216 pressed against the side surface of the microfluidic chip 104 at the one or more side ports 126, the septum 1216 can help form an air or liquid tight seal at the interface of the capillary tube 1210 and the one or more side ports 126. The other end of the capillary tube 1210 can be coupled to an external microfluidic component or system.

The fastening features in the fluidic adapter 1212, the coupling board 1214 and the cartridge 102 as shown in FIG. 12 are adapted to using screws or nails or bolts. However, other fastening techniques could also be used such as, for example, ball-and-socket, press-fit, snap-fit, clamps, magnets, etc.

FIG. 14 shows a microfluidic system 1400 in which two microfluidic modules are coupled together. The microfluidic system includes a first cartridge 1402 and a second cartridge 1452, both of which are coupled with a coupling board 1214. The first cartridge 1402 and the second cartridge 1452 can be similar to the cartridges discussed herein such as, for example, the cartridge 102. The first cartridge 1402 and the second cartridge 1452 can each be coupled with the coupling board 1214 using fasteners such as, for examples, fastening screws that engage with the at least one cartridge fastening feature 1492 of the cartridge and the at least one fastening feature 1222 of the coupling board 1214.

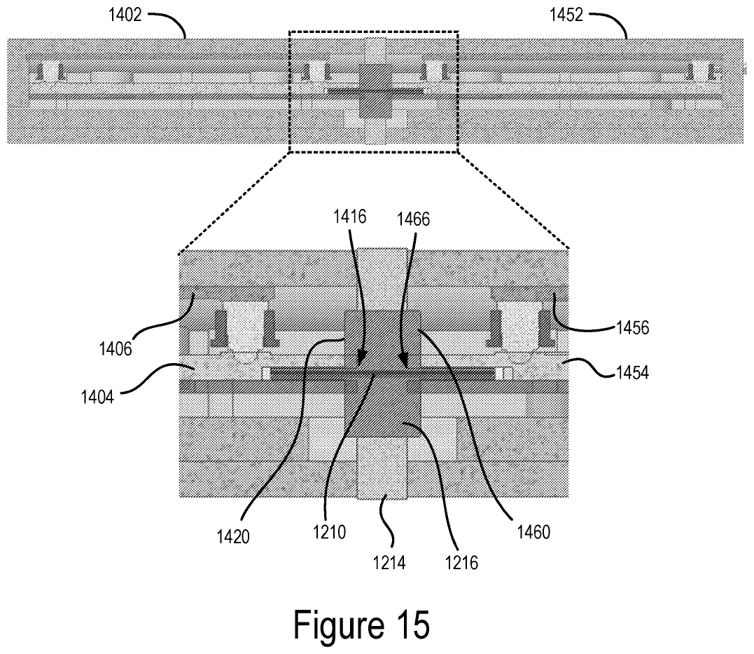

FIG. 15 shows cross-sectional views of the microfluidic system 1400 shown in FIG. 14 along an axis 1490. The first cartridge 1402 includes a first microfluidic chip 1404, a first circuit board 1406 and a first side port 1416 to a first microfluidic channel. The second cartridge 1452 includes a second microfluidic chip 1454, a second circuit board 1456, and a second side port 1466 to a second microfluidic channel. The second cartridge also includes at least one opening that allows access to the at least one microfluidic channel on the second microfluidic chip. The capillary tube 1210 is positioned such that one end of the capillary tube 1210 is inserted into the first microfluidic channel through the first side port 1416 and the second end of the capillary tube 1210 is inserted into the second microfluidic channel through the second side port 1466. The capillary tube 1210 passes through the septum capillary tube conduit 1226 of the septum 1216, which, in turn, is positioned within the at least one conduit 1224 of the coupling board 1214. The septum 1216 has a first side 1420 that rests against the first microfluidic chip 1404 at the interface of the capillary tube 1210 and the first side port 1416 and a second side 1460 that rests against the second microfluidic chip 1454 at the interface of the capillary tube 1210 and the second side port 1466. Then thickness of the septum 1216 can be grater than the thickness of the coupling board 1214. As a result, when the first cartridge 1402 and the second cartridge 1452 are fastened to the coupling board 1214, the septum 1216 gets compressed between the side surfaces of the first microfluidic chip 1404 and the second microfluidic chip 1454. This compression can cause a liquid or gas leak-proof connection between each end of the capillary tube 1210 and the respectively coupled microfluidic channel. One advantage of the coupling between the first cartridge 1402 and the second cartridge 1452 is that the dead volume in the capillary tube 1210 is considerably reduced. Traditional systems would need long capillary tubes to be routed from the first cartridge 1402 to the second cartridge 1452. The long capillary tubes, in turn, increase the volume of the channel that the fluid has to traverse from the first cartridge 1402 to the second cartridge 1452. By using the coupling board 1214 to couple the two cartridges on either side of the coupling board 1214, the two cartridges can be positioned to minimize the length of the capillary tube, thereby reducing the dead volume.

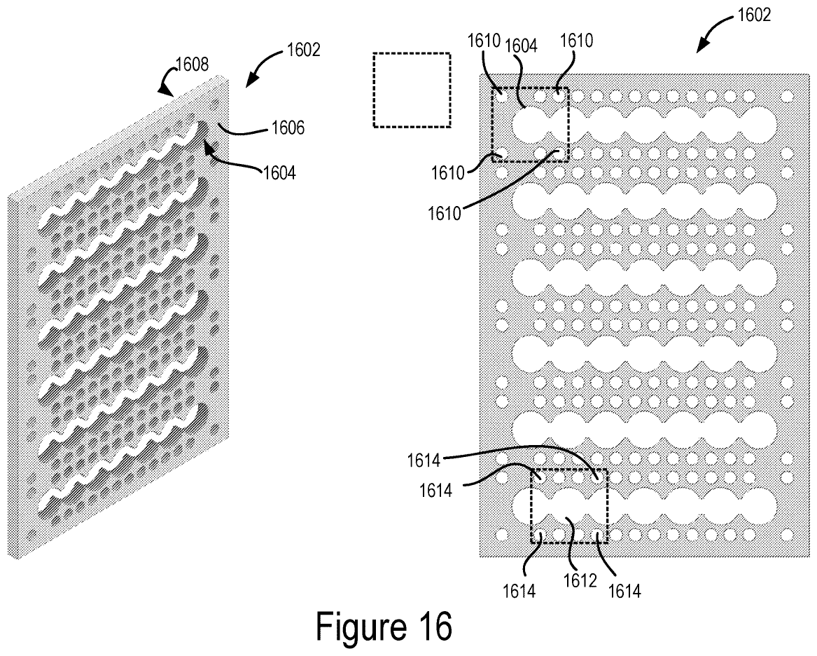

FIG. 16 shows an example coupling board 1602 including multiple conduits. In particular, FIG. 16 shows a perspective view and a front view of the coupling board 1602. The coupling board 1602 can include a plurality of conduits, and in the example shown in FIG. 16, the plurality of conduits are arranged in multiple rows. However, in some other instances, other arrangements of the conduits can be implemented. Each conduit 1604 can extend between a first surface 1606 and a opposite facing second surface 1608. The conduit 1604 can be similar to the at least one conduit 1224 discussed above in relation to FIG. 12 and can accommodate a septum and a capillary tube to pass therethrough. As in the coupling board 1214 shown in FIG. 12, where each of the at least one conduit 1224 had a corresponding set of fastening features 1222, the conduit 1604 also includes a corresponding set of fastening features. For example, assuming the conduit 1604 is a first conduit, the first conduit can include four fastening features 1610. Similarly, the coupling board 1602 can include a second conduit 1612, which can have four corresponding fastening features 1614. In this manner, the coupling board 1602 can include multiple conduits with corresponding set of fastening features. In the example shown in FIG. 16, the coupling board 1602 includes six rows of conduits, where each row includes seven conduits and corresponding set of fastening features. As the fastening features are positioned both on top and the bottom of the conduits, each row of conduits is separated by two rows of fastening features. Again, this is specific to the example shown in FIG. 16, and that other implementations may have a different arrangement of the conduits in relation to the fastening features. For the conduits shown in FIG. 16, adjacent conduits overlap. However, in some other instances, for example, where the diameter of the conduit is small, or the distance between adjacent conduits is large, there may be no overlap between adjacent conduits.

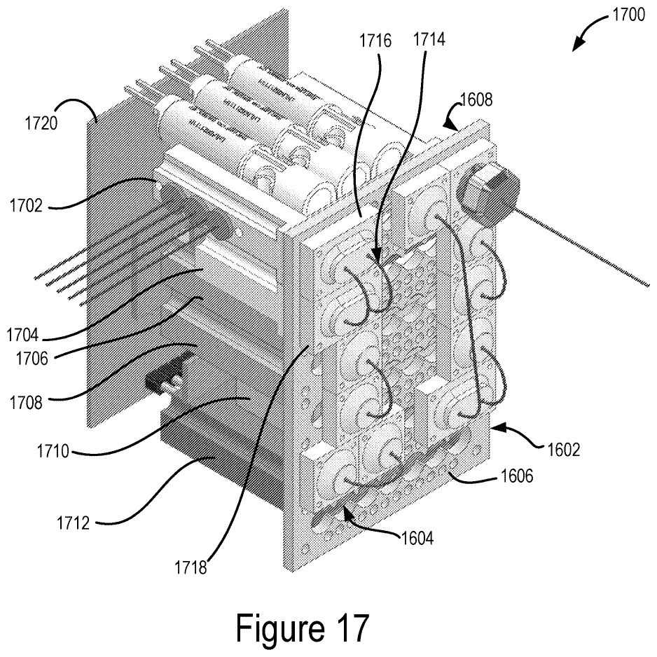

The coupling board 1602 can allow multiple microfluidic modules, similar to those discussed herein, to be coupled with each other to form microfluidic systems. FIG. 17 shows an example microfluidic system 1700 based on the coupling board 1602 shown in FIG. 16. The example microfluidic system 1700 includes several microfluidic modules or cartridge coupled on the second surface 1608 of the coupling board 1602 and one or more fluidic adapters positioned on the first surface 1606 of the coupling board 1602. For example, the microfluidic system 1700 includes a first microfluidic module 1702 including valves or pumps, a second microfluidic module 1704 including a preconcentrator, a third microfluidic module 1706 and a fourth microfluidic module 1708 including microfluidic channels, a fifth microfluidic module 1710 including a microfluidic detector, and a sixth microfluidic module 1712 including only electrical components. These microfluidic modules are fastened to the coupling board 1602 such that the microfluidic channel openings in each of the modules is aligned with the conduits of the coupling board 1602. That is, one end of a capillary tube is inserted into the microfluidic channel through, for example, a side port, while the other end of the capillary tube is routed to the desired location. For example, a first capillary tube 1714 extends between the first microfluidic module 1702 and the second microfluidic module 1704. One end of the first capillary tube 1714 is positioned in the microfluidic channel of the first microfluidic module 1702. The first capillary tube 1714 then passes through a septum positioned within the conduit of the coupling board 1602 and out through a first fluidic adapter 1716. The first capillary tube 1714 continues through a second fluidic adapter 1718, a second septum positioned within a second conduit of the 1602, and terminates into a microfluidic channel of the second microfluidic module 1704.

Similarly, other capillary tubes can be routed from one microfluidic module to another by routing the capillary tubes in the desired manner form one fluidic adapter to another fluidic adapter positioned across from the desired microfluidic module. The microfluidic system 1700 thus can enable forming a desired microfluidic system with great flexibility. Microfluidic modules can be easily replaced by removing the fasteners that attach the modules to the coupling board 1602. Similarly, fluidic connections between modules can be readily changed by rerouting the capillary tubes through a different fluidic adapter positioned across the desired module.

The microfluidic system 1700 also can include an external circuit board 1720 that can make electrical connections with the at least one interface interconnect (e.g., at least one interface interconnect 122) of a circuit board of the microfluidic module. The external circuit board 1720 can include additional electrical components and/or control circuitry for controlling the operation of the microfluidic system 1700 and can send and receive electrical signals to and from the various microfluidic modules. The external circuit board 1720 may also include power supplies that provide power to the circuit boards of the various microfluidic modules.

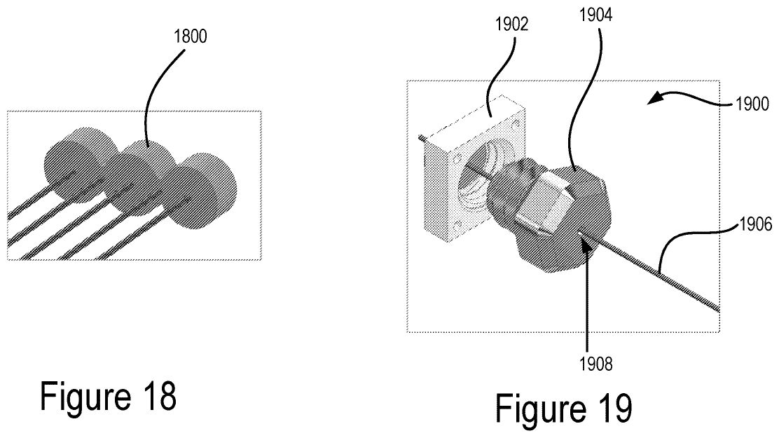

FIG. 18 shows an example septum for use in coupling boards with multiple overlapping conduits. In particular, the example septum 1800 can be positioned within the overlapping conduits of the coupling board 1602 shown in FIG. 16. The septum 1800 can include multiple septum capillary tube conduits to allow multiple capillary tubes to pass through. The shape of the septum 1800 substantially conforms to the shape of the overlapping conduits shown in FIG. 16.

FIG. 19 shows an example thumb screw adapter 1900 that can be utilized in a microfluidic system. The thumb screw adapter 1900 can be used in place of the fluidic adapter 1212 shown in FIG. 12 or the first fluidic adapter 1716 shown in FIG. 17. The thumb screw adapter 1900 can include an adapter base 1902 and an apertured screw 1904. The adapter base 1902 can include an opening to accommodate the threaded portion of the 1904 such that turning the apertured screw 1904 in one direction can secure the apertured screw 1904 to the adapter base 1902 and turning the apertured screw 1904 in the opposite direction can allow a user to separate the apertured screw 1904 from the adapter base 1902. The apertured screw 1904 can include an aperture 1908 that can allow a capillary tube 1906 to pass through.

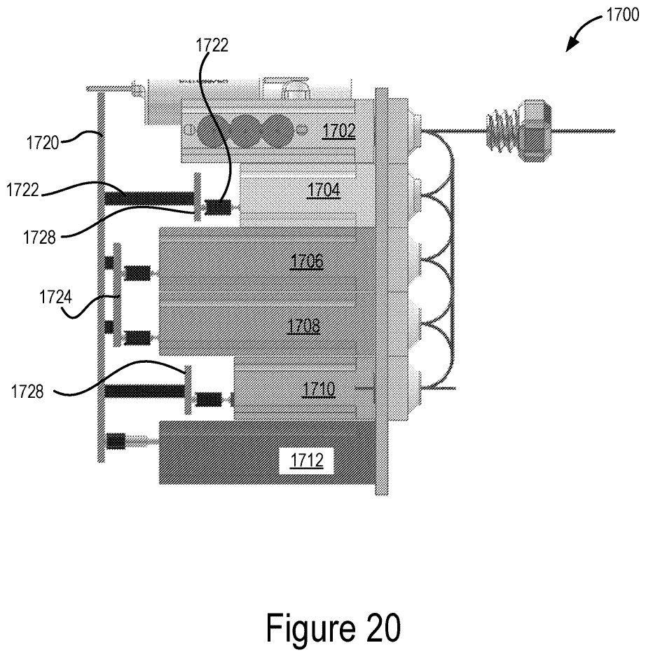

FIG. 20 shows a side view of the microfluidic system 1700 shown in FIG. 7. In particular, FIG. 20 shows additional circuit boards and interconnects that allow connections between the microfluidic modules of different sizes and the external circuit board 1720. For example, the second microfluidic module 1704 has a depth that is smaller than the depth of the third microfluidic module 1706. As such, one or more connectors 1722 and intermediate circuit boards 1728 can be employed to connect the circuit board on the second microfluidic module 1704 with the external circuit board 1720. The microfluidic system 1700 can also include intermediate circuit boards 1724 that connect to more circuit boards of more than one microfluidic modules, e.g., the third microfluidic module 1706 and the fourth microfluidic module 1708.

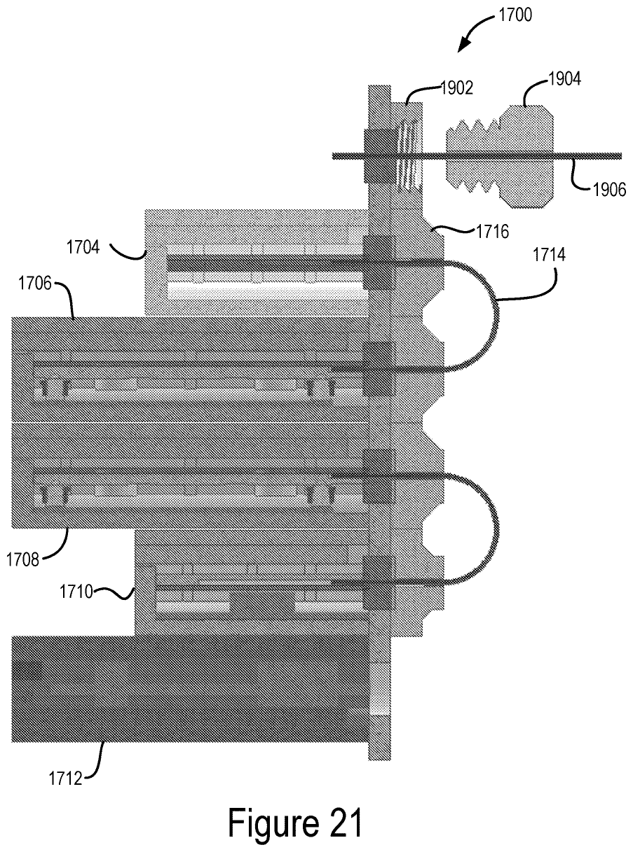

FIG. 21 shows a portion of the cross-sectional view of the microfluidic system 1700 shown in FIG. 17. FIG. 21 in particular shows the routing of the capillary tubes between two microfluidic modules. For example, the first capillary tube 1714 is routed between the second microfluidic module 1704 and the third microfluidic module 1706 and a second capillary tube 1730 is routed between the fourth microfluidic module 1708 and the fifth microfluidic module 1710.

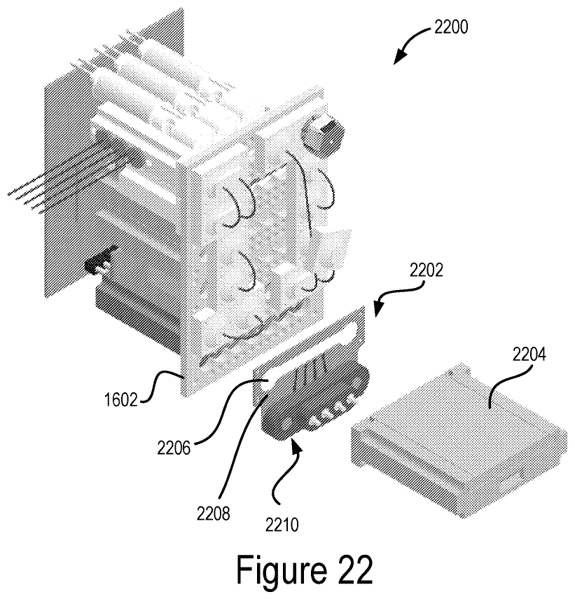

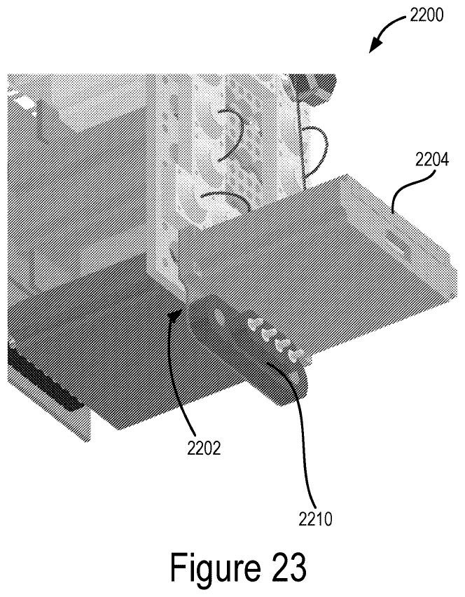

FIG. 22 shows a second microfluidic system 2200 where microfluidic modules are positioned on both sides of the coupling board 1602. In addition, the second microfluidic system 2200 includes an electrical connector 2202 that can connect to interconnects exposed by the first opening 128 of the microfluidic module 2204. While FIG. 22 shows an exploded view of the electrical connector 2202 and the microfluidic module 2204, FIG. 23 shows a perspective view of the electrical connector 2202 and the microfluidic module 2204 coupled with the coupling board 1602. The electrical connector 2202 can include circuit board portion 2208 having an opening 2206 and a connector portion 2210. The circuit board portion 2208 can be positioned between the coupling board 1602 and the microfluidic module 2204, where the opening 2206 can align with the first opening 128 of the microfluidic module 2204. The opening 2206 can allow fluidic connections to be made between the microfluidic module 2204 and other microfluidic modules coupled to the coupling board 1602. The connector portion 2210 can include connectors that can be coupled with external circuit board that are positioned on the side of the coupling board 1602 to which the microfluidic module 2204 is positioned.

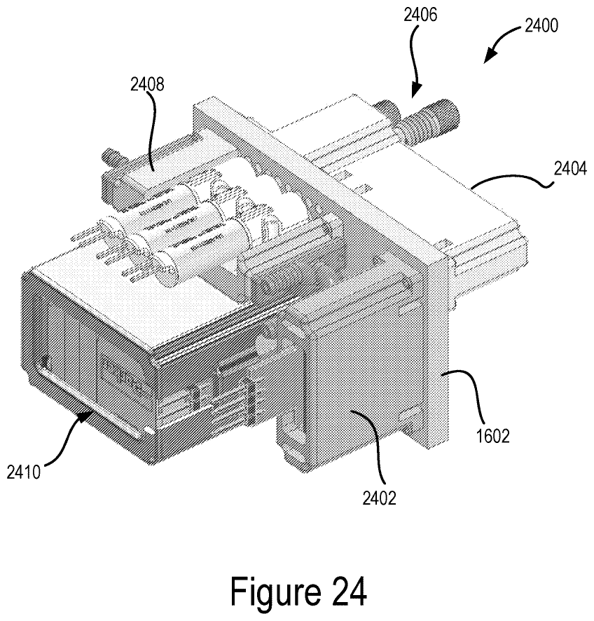

FIG. 24 shows a third microfluidic system 2400 that represents a micro gas chromatography system with near-zero dead volume chip-chip connections. The third microfluidic system 2400 can include a separation module 2402, a preconcentrator 2404, fluidic routing module 2408, a diaphragm pump module 2410, and a needle valve cartridge 2406. These components are coupled to both sides of the coupling board 1602 such that the microfluidic channels of various modules are coupled to each other in the manner discussed above in relation to FIG. 15. That is, the length of the capillary tube connecting across modules is minimized to reduce dead volume between the modules. Such as system can provide better efficiency of operation than traditional systems with long capillary tubes that undesirably have large dead volumes.

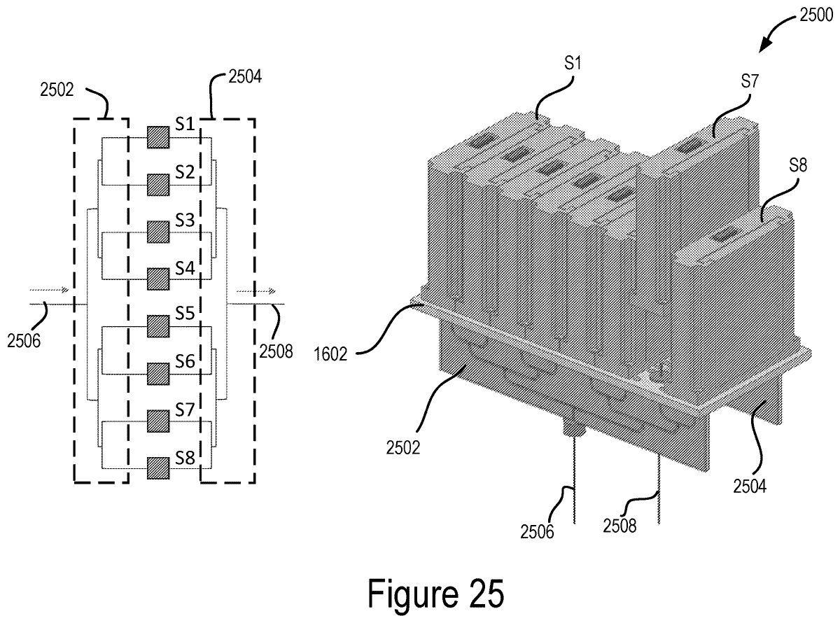

FIG. 25 shows a fourth microfluidic system 2500 for use during development of microfluidic chips. Generally, during the manufacture of microfluidic chips, after the chips have been diced from the wafer, capillary tubes are attached to the fluidic ports of the chips using epoxy to provide access to the microfluidic channels of the chips. The capillary tubes are then used to individually functionalize the chips. The individual functionalization of the chips can be time consuming. In the example show in FIG. 25, the fourth microfluidic system 2500 can enable simultaneous functionalization of multiple chips at the same time. FIG. 25 shows several microfluidic modules (S1-S8) connected in parallel to the coupling board 1602. On the other side of the coupling board 1602, a first parallel coupling board 2502 and a second parallel coupling board 2504 are attached. The first parallel coupling board 2502 and the second parallel coupling board 2504 can be positioned on the second surface of the coupling board 1602. The first parallel coupling board 2502 can include a first network of microfluidic channels having an inlet and a plurality of outlets in fluid communication with the inlet, and the second parallel coupling board 2504 can include a second network of microfluidic channels having a plurality of inlets and an outlet in fluid communication with the plurality of inlets The plurality of outlets of the first parallel coupling board 2502 can be aligned with a first set of conduits of the coupling board 1602 and where the plurality of inlets of the second parallel coupling board 2504 can be aligned with a second set of conduits of the coupling board 1602. The first set of conduits of the coupling board 1602 can in turn be aligned with inlets of the plurality of microfluidic modules (S1-S8) and the second set of conduits can be aligned with the outlets of the plurality of microfluidic modules (S1-S8). A solvent containing the reagent (e.g., a solvent for a stationary phase or an adsorbent for a preconcentrator) can enter an inlet 2506 and be automatically distributed to all the microfluidic modules (S1-S8) simultaneously via the first parallel coupling board 2502 and exit through the outlet 2508 via the second parallel coupling board 2504.

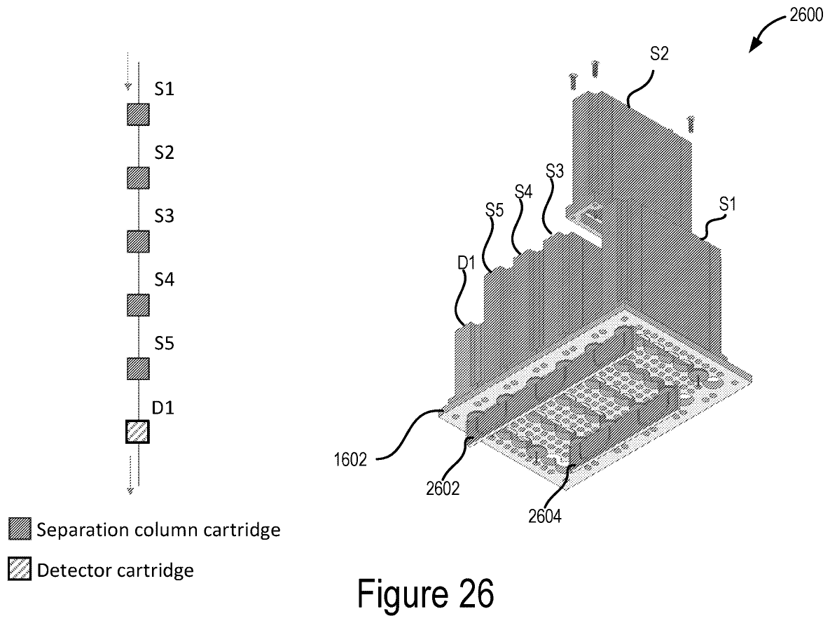

FIG. 26 shows a fifth microfluidic system 2600. Fabrication of long microfluidic separation columns (such as, e.g., those used in micro-gas chromatography applications) can be very challenging due to reduced yield and process non-uniformities across the wafer during chip microfabrication. In some examples, functionalization of long separation columns including semi-packed columns can be very difficult. Using the fifth microfluidic system 2600, multiple shorter columns can be fabricated, functionalized, and then integrated into the system enabling a high-degree of flexibility and reconfigurability. FIG. 26 shows an example of serially coupled separation columns (S1-S5) to form a long column using multiple smaller separation column cartridges. It also shows two microfabricated coupling boards: a first coupling board 2602 and a second coupling board 2604 to interface all the separation columns. Using this approach, substantially long (e.g., up to 10 m-long, or up to 5 m long, etc.) columns can be achieved by connecting the multiple modules each containing a segment of the separation columns. The modules S1-S5 including separation columns can have on-board heaters and temperature sensors for active temperature control of transfer lines if needed. Such an approach can reduce the need for using long capillary tubes between separate modules and can further reduce cold spots and increase system performance. In some examples, the fifth microfluidic system 2600 can also include a detector cartridge D1 at the end of the separation column formed by S1-S5. The plurality of cartridges of microfluidic modules (labeled S1-S5 and D1) can be positioned on the first surface of the coupling board 1602, where each of the cartridges can include a microfluidic channel having an inlet and an outlet. The inlets of the cartridges can be aligned with a first set of conduits of the coupling board 1602 and the outlets of the cartridges can be aligned with a second set of conduits of the coupling board 1602. The first or second parallel coupling board can include a plurality of microfluidic channels, whare each coupling board includes a board inlet and a board outlet. The coupling board inlets can be aligned with a second set of conduits in the coupling board 1602 and the coupling board outlets can be aligned with the first set of conduits of the coupling board 1602.

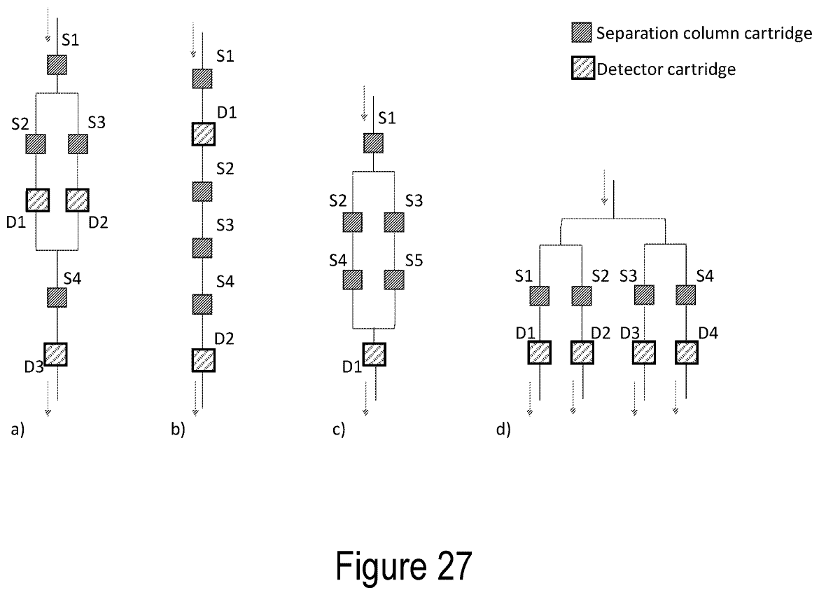

FIG. 27 shows various examples of microfluidic systems that can be implemented with coupling boards such as those discussed above in relation to FIGS. 25-26. In particular, FIG. 27 shows various examples of microfluidic systems that can be implemented by fabricating the coupling boards accordingly. The coupling boards can provide various combinations of parallel and serial fluid paths between microfluidic modules coupled with the coupling board 1602.

Aspects: the following provides details of various aspects in relation to the disclosure.

Aspect 1: This aspect includes an apparatus, including: a microfluidic chip including at least one microfluidic channel and a first at least one electrical interconnect; a circuit board having at least one interface interconnect and a second at least one electrical interconnect electrically coupled with the first at least one electrical interconnect of the microfluidic chip; and a cartridge enclosing the microfluidic chip and the circuit board, the cartridge including at least one opening allowing access to the at least one microfluidic channel on the microfluidic chip and the at least one interface interconnect.

Aspect 2: An aspect in combination with any one of the aspects 1, 3-22, wherein the microfluidic chip includes at least one electronic component coupled with the at least one microfluidic channel and electrically coupled with the first at least one electrical interconnect.

Aspect 3: An aspect in combination with any one of the aspects 1-2, 4-22, wherein the cartridge includes at least one alignment feature on an inner surface of the cartridge, wherein the microfluidic chip further includes complementary at least one alignment feature that engages with the at least one alignment feature.

Aspect 4: An aspect in combination with any one of the aspects 1-3, 5-22, wherein the microfluidic chip includes at least one opening to the at least one microfluidic channel, wherein a portion of the cartridge over the at least one opening includes a magnifying lens.

Aspect 5: An aspect in combination with any one of the aspects 1-4, 5-22, wherein the cartridge includes a first side defining a first opening of the at least one opening and a second side defining a second opening of the at least one opening, wherein the first opening allows access to the at least one microfluidic channel and the second opening allows access to the at least one interface interconnect.

Aspect 6: An aspect in combination with any one of the aspects 1-5, 7-22, wherein the cartridge includes a first side defining the at least one opening.

Aspect 7: An aspect in combination with any one of the aspects 1-6, 8-22, wherein the cartridge includes a retractable cover, which in a retracted state exposes an internal volume of the cartridge and in a closed state presses the microfluidic chip against the circuit board.

Aspect 8: An aspect in combination with any one of the aspects 1-7, 9-22, wherein the cartridge includes a hinge coupled with the retractable cover.

Aspect 9: An aspect in combination with any one of the aspects 1-8, 10-22, wherein the cartridge includes sliding grooves on an inner surface of the cartridge, the sliding grooves accommodating the retractable cover and allowing the retractable cover to slide in and out of the cartridge.

Aspect 10: An aspect in combination with any one of the aspects 1-9, 11-22, the apparatus further including spring contacts positioned between the first at least one interconnect and the second at least one interconnect, the spring contacts providing electrical contact between the first at least one interconnect and the second at least one interconnect and a force pushing the circuit board away from the microfluidic chip, wherein the cartridge compress-fits the circuit board against the microfluidic chip.

Aspect 11: An aspect in combination with any one of the aspects 1-10, 12-22, the apparatus further including a spacer positioned between an inner surface of the cartridge and one of the microfluidic chip or the circuit board, a thickness of the spacer being selected to align the at least one microfluidic channel on the microfluidic chip and the at least one interface interconnect on the circuit board with the at least one opening.

Aspect 12: An aspect in combination with any one of the aspects 1-11, 13-22, wherein the circuit board includes at least one control circuit communicably coupled with the at least one electronic component on the microfluidic chip.

Aspect 13: An aspect in combination with any one of the aspects 1-12, 14-22, the apparatus further including: a coupling board, including: a first surface and an opposite facing second surface, at least one conduit that extends between the first surface and the second surface, and at least one fastening feature; a capillary tube that extends through the at least one conduit in the coupling board, wherein the cartridge includes: a first side defining a first opening of the at least one opening, the first side including at least one cartridge fastening feature that engages with the at least one fastening feature on the coupling board, wherein the capillary tube extends through the first opening in the cartridge and is in fluid communication with the at least one microfluidic channel.

Aspect 14: An aspect in combination with any one of the aspects 1-13, 15-22, the apparatus further including: a septum positioned within the at least one conduit in the coupling board and positioned at an intersection of the capillary tube and the at least one microfluidic channel to form a fluidic-tight seal, wherein the septum includes a septum capillary tube conduit and wherein the capillary tube extends through the septum capillary tube conduit.

Aspect 15: An aspect in combination with any one of the aspects 1-14, 16-22, the apparatus further including: a fluidic adapter positioned on the first surface of the coupling board, the fluidic adapter including an adapter capillary tube conduit, wherein the capillary tube extends through the adapter capillary tube conduit.

Aspect 16: An aspect in combination with any one of the aspects 1-15, 17-22, wherein the fluidic adapter includes at least one fastening features which engage with the at least one fastening features in the coupling board.

Aspect 17: An aspect in combination with any one of the aspects 1-16, 18-22, wherein the cartridge is a first cartridge, the microfluidic chip is a first microfluidic chip, and the circuit board is a first circuit board, the apparatus further including: a second microfluidic chip, a second circuit board, and a second cartridge enclosing the second microfluidic chip and the second circuit board, the second cartridge including at least one opening allowing access to at least one microfluidic channel on the second microfluidic chip and at least one interface interconnect on the second circuit board, the second cartridge further including a first side having at least one cartridge fastening feature, wherein the second cartridge is positioned on the second surface of the coupling board, wherein the at least one cartridge fastening feature of the second cartridge engages with the at least one fastening feature of the coupling board, and wherein the capillary tube extends between the at least one microfluidic channel in the first microfluidic chip and the at least one microfluidic channel in the second microfluidic chip through the at least one conduit in the coupling board.

Aspect 18: An aspect in combination with any one of the aspects 1-17, 19-22, wherein the at least one conduit includes a plurality of conduits and the at least one fastener feature includes a plurality of fastener features, wherein for each conduit of the plurality of conduits there is a corresponding set of fastener features from the plurality of fastener features, and wherein a relative position of a first conduit from the plurality of conduits with respect to its corresponding set of fastener features from the plurality of fastener features is same as a relative position of every other conduit of the plurality of conduits with respect to its corresponding set of fastener features form the plurality of fastener features.

Aspect 19: An aspect in combination with any one of the aspects 1-18, 20-22, wherein the plurality of conduits are positioned in an array of rows and columns.

Aspect 20: An aspect in combination with any one of the aspects 1-19, 21-22, the apparatus further including: a plurality of cartridges, including the cartridge, positioned on the first surface of the coupling board; a plurality of fluidic adapters positioned on the second surface of the coupling board, each of the plurality of fluidic adapters including an adapter capillary tube conduit, wherein a capillary tube extends between a first cartridge of the plurality of cartridges and a second cartridge of the plurality of cartridges and passes through a first conduit of the plurality of conduits, an adapter capillary conduit of a first fluidic adapter of the plurality of fluidic adapters, an adapter capillary conduit of a second fluidic adapter of the plurality of fluidic adapters, and a second conduit of the plurality of conduits.

Aspect 21: An aspect in combination with any one of the aspects 1-20, and 22, the apparatus further including: a plurality of cartridges, including the cartridge, positioned on the first surface of the coupling board, wherein each cartridge includes a microfluidic channel having an inlet and an outlet, wherein inlets of the plurality of cartridges are aligned with a first set of conduits of the plurality of conduits and wherein outlets of the plurality of cartridges are aligned with a second set of conduits of the plurality of conduits, a first parallel coupling board and a second parallel coupling board positioned on the second surface of the coupling board, the first parallel coupling board including a first network of microfluidic channels having an inlet and a plurality of outlets in fluid communication with the inlet, and the second parallel coupling board including a second network of microfluidic channels having a plurality of inlets and an outlet in fluid communication with the plurality of inlets, wherein the plurality of outlets of the first parallel coupling board are aligned with the first set of conduits of the coupling board, and wherein the plurality of inlets of the second parallel coupling board are aligned with the second set of conduits of the coupling board.

Aspect 22: An aspect in combination with any one of the aspects 1-21, the apparatus further including: a plurality of cartridges, including the cartridge, positioned on the first surface of the coupling board, wherein each cartridge includes a microfluidic channel having an inlet and an outlet, wherein inlets of the plurality of cartridges are aligned with a first set of conduits of the plurality of conduits and wherein outlets of the plurality of cartridges are aligned with a second set of conduits of the plurality of conduits, a parallel coupling board including a plurality of microfluidic channels, each microfluidic channel including a coupling board inlet and a coupling board outlet, wherein coupling board inlets are aligned with the second set of conduits in the coupling board and the wherein coupling board outlets are aligned with the first set of conduits of the coupling board.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

1. An apparatus, comprising:
a microfluidic chip including at least one microfluidic channel and a first at least one electrical interconnect;
a circuit board having at least one interface interconnect and a second at least one electrical interconnect electrically coupled with the first at least one electrical interconnect of the microfluidic chip; and
a cartridge enclosing the microfluidic chip and the circuit board, the cartridge including at least one opening allowing access to the at least one microfluidic channel on the microfluidic chip and the at least one interface interconnect.

2. The apparatus of claim 1, wherein the microfluidic chip includes at least one electronic component coupled with the at least one microfluidic channel and electrically coupled with the first at least one electrical interconnect.

3. The apparatus of claim 1, wherein the cartridge includes at least one alignment feature on an inner surface of the cartridge, wherein the microfluidic chip further includes complementary at least one alignment feature that engages with the at least one alignment feature.

4. The apparatus of claim 1, wherein the microfluidic chip includes at least one opening to the at least one microfluidic channel, wherein a portion of the cartridge over the at least one opening includes a magnifying lens.

5. The apparatus of claim 1, wherein the cartridge includes a first side defining a first opening of the at least one opening and a second side defining a second opening of the at least one opening, wherein the first opening allows access to the at least one microfluidic channel and the second opening allows access to the at least one interface interconnect.

6. The apparatus of claim 1, wherein the cartridge includes a first side defining the at least one opening.

7. The apparatus of claim 1, wherein the cartridge includes a retractable cover, which in a retracted state exposes an internal volume of the cartridge and in a closed state presses the microfluidic chip against the circuit board.

8. The apparatus of claim 7, wherein the cartridge includes a hinge coupled with the retractable cover.

9. The apparatus of claim 7, wherein the cartridge includes sliding grooves on an inner surface of the cartridge, the sliding grooves accommodating the retractable cover and allowing the retractable cover to slide in and out of the cartridge.

10. The apparatus of claim 1, further comprising spring contacts positioned between the first at least one electrical interconnect and the second at least one interconnect, the spring contacts providing electrical contact between the first at least one electrical interconnect and the second at least one interconnect and a force pushing the circuit board away from the microfluidic chip, wherein the cartridge compress-fits the circuit board against the microfluidic chip.

11. The apparatus of claim 1, further comprising a spacer positioned between an inner surface of the cartridge and one of the microfluidic chip or the circuit board, a thickness of the spacer being selected to align the at least one microfluidic channel on the microfluidic chip and the at least one interface interconnect on the circuit board with the at least one opening.

12. The apparatus of claim 2, wherein the circuit board includes at least one control circuit communicably coupled with the at least one electronic component on the microfluidic chip.

13. The apparatus of claim 1, further comprising:
a coupling board, comprising:
a first surface and an opposite facing second surface,
at least one conduit that extends between the first surface and the second surface, and
at least one fastening feature;
a capillary tube that extends through the at least one conduit in the coupling board,
wherein the cartridge comprises:
a first side defining a first opening of the at least one opening, the first side including at least one cartridge fastening feature that engages with the at least one fastening feature on the coupling board,
wherein the capillary tube extends through the first opening in the cartridge and is in fluid communication with the at least one microfluidic channel.

14. The apparatus of claim 13, further comprising:
a septum positioned within the at least one conduit in the coupling board and positioned at an intersection of the capillary tube and the at least one microfluidic channel to form a fluidic-tight seal, wherein the septum includes a septum capillary tube conduit and wherein the capillary tube extends through the septum capillary tube conduit.

15. The apparatus of claim 14, further comprising:
a fluidic adapter positioned on the first surface of the coupling board, the fluidic adapter including an adapter capillary tube conduit, wherein the capillary tube extends through the adapter capillary tube conduit.

16. The apparatus of claim 15, wherein the fluidic adapter includes at least one fastening features which engage with the at least one fastening features in the coupling board.

17. The apparatus of claim 13, wherein the cartridge is a first cartridge, the microfluidic chip is a first microfluidic chip, and the circuit board is a first circuit board, the apparatus further comprising:
a second microfluidic chip,
a second circuit board, and
a second cartridge enclosing the second microfluidic chip and the second circuit board, the second cartridge including at least one opening allowing access to at least one microfluidic channel on the second microfluidic chip and at least one interface interconnect on the second circuit board, the second cartridge further including a first side having at least one cartridge fastening feature,
wherein the second cartridge is positioned on the second surface of the coupling board,
wherein the at least one cartridge fastening feature of the second cartridge engages with the at least one fastening feature of the coupling board, and
wherein the capillary tube extends between the at least one microfluidic channel in the first microfluidic chip and the at least one microfluidic channel in the second microfluidic chip through the at least one conduit in the coupling board.

18. The apparatus of claim 13, wherein the at least one conduit includes a plurality of conduits and the at least one cartridge fastening feature includes a plurality of fastener features, wherein for each conduit of the plurality of conduits there is a corresponding set of fastener features from the plurality of fastener features, and wherein a relative position of a first conduit from the plurality of conduits with respect to its corresponding set of fastener features from the plurality of fastener features is same as a relative position of every other conduit of the plurality of conduits with respect to its corresponding set of fastener features form the plurality of fastener features.

19. The apparatus of claim 18, wherein the plurality of conduits are positioned in an array of rows and columns.

20. The apparatus of claim 18, further comprising:
a plurality of cartridges, including the cartridge, positioned on the first surface of the coupling board;
a plurality of fluidic adapters positioned on the second surface of the coupling board, each of the plurality of fluidic adapters including an adapter capillary tube conduit,
wherein a capillary tube extends between a first cartridge of the plurality of cartridges and a second cartridge of the plurality of cartridges and passes through a first conduit of the plurality of conduits, an adapter capillary conduit of a first fluidic adapter of the plurality of fluidic adapters, an adapter capillary conduit of a second fluidic adapter of the plurality of fluidic adapters, and a second conduit of the plurality of conduits.

21-22. (canceled)
